(19) United States
(12) Patent Application Publication
(10) Pub. No.: US 2011/0216003 A1
(43) Pub. Date: Sep. 8, 2011

(54) MOUSE

(75) Inventor: HAI-QING ZHOU, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/760,448

(22) Filed: Apr. 14, 2010

(30) Foreign Application Priority Data
Mar. 5, 2010 (CN) 201010119042.9

(51) Int. Cl. G06F 3/033

(52) U.S. Cl. 345/163

(57) ABSTRACT

A mouse includes a mainbody, a number of buttons, an interface, a sensor, a controller, and a boot button. The interface includes a first group of pins and a second group of pins. The first group of pins are connected to a motherboard. The boot button connects to the second group of pins of the interface for providing an activating signal. One of the second group of pins of the interface is operable to connect to a power-on pin of the motherboard to provide the activating signal to the power-on pin, for booting the motherboard.

### BACKGROUND

1. Technical Field

The present disclosure relates to a mouse.

2. Description of Related Art

A front panel of an enclosure of a computer may include a power button for turning the computer on or off. The enclosure is often placed on a floor or a lower shelf away from use-based elements controlling the computer. To turn the computer on or off, a user often needs to reach for the power control, which is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, isometric view of an exemplary embodiment of a mouse, the mouse includes an interface.

FIG. 2 is a block diagram of the mouse in FIG. 1.

FIG. 3 is a schematic plan view of the interface in FIG. 1.

FIG. 4 is a schematic view of the interface of FIG. 3 connected to a motherboard.

### DETAILED DESCRIPTION

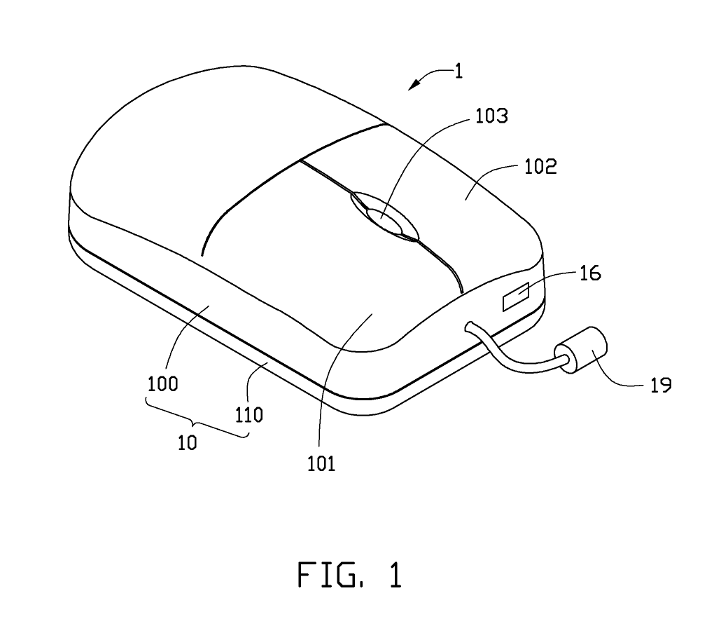

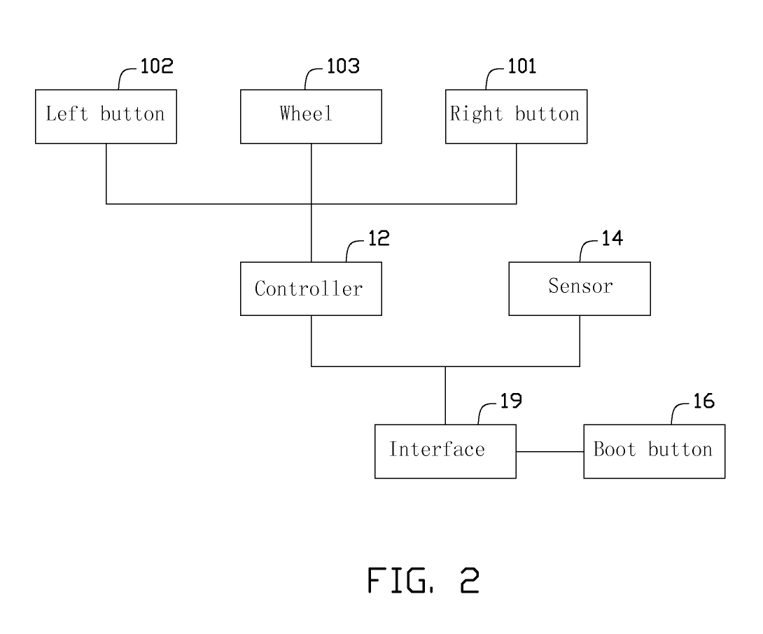

Referring to FIGS. 1 and 2, an exemplary embodiment of a mouse 1 is shown. In this embodiment the mouse 1 is an optical mouse. The mouse 1 includes a mainbody 10, a controller 12, a sensor 14, a boot button 16, and an interface 19.

The mainbody 10 includes a lower shell 110 and an upper shell 100 covering the lower shell 110 to form a shell. The controller 12 and the sensor 14 are mounted in the mainbody 10.

A right button 101, a left button 102, and a wheel 103 are mounted on a front end of the upper shell 100. In general, the right button 101 is configured as a function key. The left button 102 is configured as an input key. The wheel 103 is configured as a control key for scrolling a cursor.

The controller 12 connects to the right button 101, the left button 102, and the wheel 103. The controller 12 further connects to the interface 19.

The sensor 15 is an optical sensor for sensing movement of the mouse 1. The sensor 15 is connected to the interface 19.

The boot button 16 is mounted on the front end of the upper shell 110. In the embodiment, the boot button 16 is a non-locking button, and connects to the interface 19. The boot button 16 is mounted on the front end of the upper shell 110 to avoid mishandling of the boot button 16. In other embodiments, the boot button 16 may be mounted elsewhere on the mouse 1.

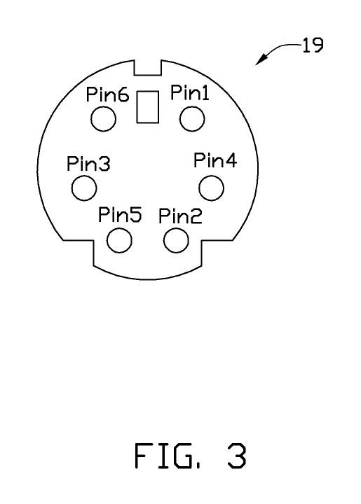

Referring to FIG. 3, the interface 19 is a personal system 2 (PS/2) interface. The interface 19 includes a clock pin Pin1, a data pin Pin2, a power pin Pin3, a ground pin Pin4, and two idle pins Pin5 and Pin6.

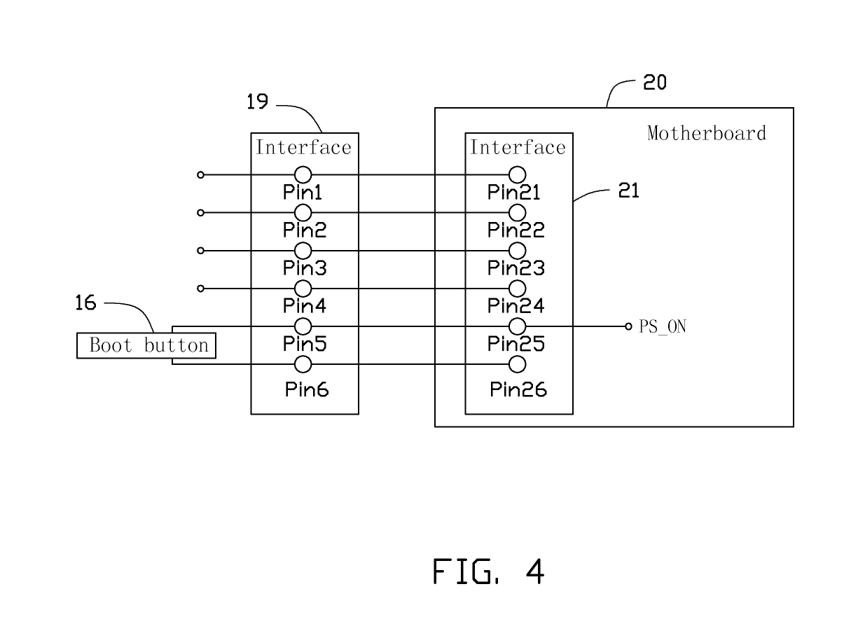

Referring to FIG. 4, the clock pin Pin1, the data pin Pin2, the power pin Pin3, and the ground pin Pin4 all connect to the controller 12. The idle pins Pin5 and Pin6 respectively connect to two ends of the boot button 16.

In use, the interface 19 of the mouse 1 connects to an interface 21 of a motherboard 20. The interface 21 is a PS/2 interface. The interface 21 includes a clock pin P21, a data pin P22, a power pin P23, a ground pin P24, and two idle pins P25 and P26. The clock pin Pin1, the data pin P2, the power pin P3, and the ground pin P4 of the interface 19 respectively connect to the clock pin P21, the data pin P22, the power pin P23, and the ground pin P24, for transmitting signals between the mouse 1 and the motherboard 20. The idle pin P25 or P26 connects to a power-on pin PS_ON of the motherboard 20.

When the boot button 16 is pressed, a signal is transmitted to the power-on pin PS_ON of the motherboard 20 via the interfaces 19 and 20. Upon the condition that the power-on pin PS_ON receives the signal, the motherboard 20 is booted. In this embodiment, the signal may be a low level signal or a high level signal corresponding to the motherboard 20.

The above discussion is directed to an optical mouse. It can be understood that one skilled in the art will understand that in other embodiments, the mouse 1 may be a mechanical mouse.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A mouse comprising:
a mainbody;
a plurality of buttons;
an interface comprising a first group of pins and a second group of pins, wherein the first group of pins are connected to a motherboard;
a sensor located inside the mainbody, for sensing movement of the mouse;
a controller located inside the mainbody, for controlling the plurality of buttons; and
a boot button connected to the second group of pins of the interface, for providing a signal, wherein one of the second group of pins of the interface is connected to a power-on pin of the motherboard to provide the signal to the power-on pin, for booting the motherboard.

2. The mouse of claim 1, wherein the interface is a personal system 2 interface, the first group of pins of the interface comprise a clock pin, a data pin, a power pin, and a ground pin, the second group of pins of the interface comprise two idle pins.

3. The mouse of claim 1, wherein the mainbody comprises a lower shell and an upper shell, to receive the sensor and the controller, the boot button locates on a front end of the lower shell.

4. The mouse of claim 1, wherein the boot button is a non-locking button.

5. The mouse of claim 1, wherein the signal is a low level signal.

6. The mouse of claim 1, wherein the signal is a high level signal.
